(19) United States
(12) Patent Application Publication
(10) Pub. No.: US 2004/0208977 A1
(43) Pub. Date: Oct. 21, 2004

(54) Pearl starch ball product with filling of natural fruits or vegetables

(76) Inventors: Mei-Li Chuang Chien, Hsin-Chuang City (TW); Min-Chih Chuang, Hsin-Chuang City (TW); Min-Jan Chuang, Hsin-Chuang City (TW)

Correspondence Address: Mei-Li Chuang Chien, Min-Chih Chuang & Min-Jan Chuang, P.O. Box No. 6-57, Chung-Ho City, Taipei Hsien, 235, TW

(21) Appl. No.: 09/887,044

(22) Filed: Jun. 25, 2001

(51) Int. Cl. A23K 1/00

(52) U.S. Cl. 426/615

(57) ABSTRACT

A pearl starch ball product with filling of natural fruits or vegetables, the said pearl starch ball product can be divided into at least an inner layer and an outer layer, the inner layer is the filling ingredient primarily made of fruits, five grains, vegetables or healthy food ingredients from Chinese herb medicines, the outer layer is a starch layer covering on the external periphery of the filling ingredient, wherein the filling ingredient can be further divided into more than two layers of different ingredient layers, from the inside to the outside respectively, the first layer is a layer of fruits or vegetables, the second layer is a sugar coating, etc.; the implement of the present invention enables the pearl starch ball not only possess the original chewy texture, but also possess the luscious flavor of the grains of natural fruits or vegetables.

### BACKGROUND OF THE INVENTION

1) Field of the Invention

The pearl starch ball product of the present invention comprises of a filling ingredient and a starch layer covering on the external periphery of the filling, wherein in the filling ingredient is made of natural grains of natural fruits, five grains, vegetables or grains of fruit jello with fitted original flavor; in addition to the chewy texture of the filling ingredient of this kind of pearl starch ball, the luscious taste of the filling ingredient also makes the pearl starch ball possess special quality different from the traditional tasteless pearl starch ball.

2) Description of the Prior Art

The manufacturing procedure of a conventional pearl starch ball, as shown in FIG. 1, indicates that the product is made into molds by adding water and food coloring to starch followed by the steps of mixing, blending, crushing the starch particles, forming the grains, molding and sifting; the mold of the said pearl starch ball (10) is shown in FIG. 2. However, since the conventional pearl starch ball (10) is made of starch layer (11) (tapioca flour), it is tasteless and needs to be taken with hot or cold beverages with sugary ingredients, therefore its taste mainly comes from the accompanying beverages; when the pearl starch ball and the beverage is taken into the mouth, only the sweetness of the beverage can be tasted and then disappears into tasteless flavor after the pearl starch ball is chewed, therefore, a tasteful pearl starch ball is researched, developed and innovated by some of the manufactures.

The manufacturing procedure of the tasteful pearl starch ball, as shown in FIG. 3, indicates that the product is molded by adding water, food coloring and the filling powder (such as the plum, the pineapple, the peanut, the sesame, the coffee powder, etc.) to starch and also followed by the steps of mixing, blending, crushing the starch particles, forming the grains, molding and sifting; the structure of the said pearl starch ball (20) is shown in FIG. 4. To compare with the previous tasteless pearl starch ball (10), the difference is that the starch layer (21) is added by the filling powder (22), the filling powder (22) is distributed inside the pearl starch ball (20); the shortcoming thereof is that only light flavor of the filling can be tasted during chewing with no luscious flavor generated, therefore it fails to satisfy the consumer's palatal desire.

In order to satisfy the multiple tastes of the consumers, the inventor of the present invention further developed an improved pearl starch ball with filling filed in another patent application case (U.S. Ser. No. 09/588,331); the manufacturing procedure is shown in FIG. 5, wherein the first step is to mold the filling ball by mixing the filling powder, water and the additional substance followed by mixing, blending, crushing the starch particles, forming the grains; the second step is to form the crushed starch flour by mixing starch, water and food coloring followed by mixing, blending, crushing the starch particles; the third step is to use the grain-forming machine to mold the pearl starch ball with filling (30) after mixing the filling ball and the crushed starch, the structure thereof is shown in FIG. 6, wherein the inner layer is the filling ball (31), the outer layer is the starch layer (32); in addition to the chewy texture to be tasted after chewing the said pearl starch ball (30), the luscious flavor of the filling ball (31) is also possessed, therefore, the effect of the texture is better than that of the previous product.

However, since the conventional filling ball is made by mixing filling powder, water and additional substance, therefore it is manufactured completely through processing with artificial supplements and is not made from natural food; in order to pursue the benefit of the natural and original flavor, the natural food product will be the best manufactured one.

### SUMMARY OF THE INVENTION

FIG. 7 is the drawing of the manufacturing steps of the present invention of a pearl starch ball with filling and FIG. 8 indicates the structure of the pearl starch, the manufacturing procedure includes three steps, respectively they are:

The first step is to pare the fruits (such as the peaches, the plums, the prunes, the pineapples, the apples, the mangos, the bananas, the papayas, and the coconut pulp), remove the seeds and cut the fruits into the shapes of grain to form grains of filling ingredients (41);

The second step is to use the blender to mix and blend the starch flour (tapioca flour), water and food coloring (for changing the colors), then use the particle crusher to crush the starch flour into crushed starch (42);

The third step is to put the mentioned filling ingredients (41) and the crushed starch (42) into the grain-forming machine to mold spherical pearl ball through grain forming, wherein the inner layer is the filling ingredients (41) and the outer layer is the starch layer (42).

The fruits mentioned in the first step can be replaced with the five grains, such as the rice grains, the soybeans, the green beans, the red beans and the lima beans; since the five grains are grains already so they can be used right after been washed, steamed or cooked and seasoned (with sugar, for example); in addition, healthy food ingredients from Chinese herb medicines can also be used as substitutes, such as the medlars, the dates, the lotus nuts, the myotonins, etc., the manufacturing method is the same as that for the mentioned five grains.

### BRIEF DESCRIPTION OF THE DRAWINGS

FIG. 1 is a manufacturing flow chart of the first kind of conventional pearl starch ball (1).

FIG. 2 is an entire cross-sectional drawing of the first mentioned conventional pearl starch ball (1).

FIG. 3 is a manufacturing flow chart of the second mentioned conventional pearl starch ball (2).

FIG. 4 is an entire cross-sectional drawing of the second kind of conventional pearl starch ball (2).

FIG. 5 is a manufacturing flow chart of the pearl starch ball of the previous invention.

FIG. 6 is an entire cross-sectional drawing of the pearl starch ball of the previous invention.

FIG. 7 is a manufacturing flow chart of the pearl starch ball of the present invention.

FIG. 8 is an entire cross-sectional drawing of the pearl starch ball of the present invention.

FIG. 9 is a manufacturing flow chart of another kind of pearl starch ball (1) of the present invention.

FIG. 10 is an entire cross-sectional drawing of another kind of pearl starch ball (1) of the present invention.

FIG. 11 is a manufacturing flow chart of yet another kind of pearl starch ball (2) of the present invention.

FIG. 12 is an entire cross-sectional drawing of yet another kind of pearl starch ball (2) of the present invention.

FIG. 13 is a manufacturing flow chart of still another kind of pearl starch ball (3) of the present invention.

FIG. 14 is an entire cross-sectional drawing of still another kind of pearl starch ball (3) of the present invention.

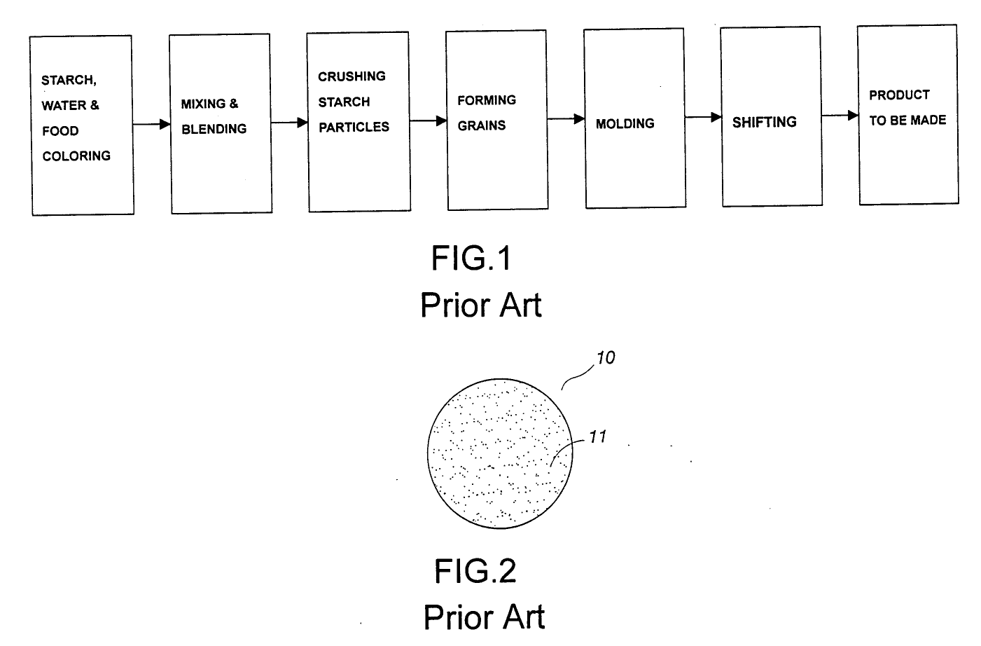

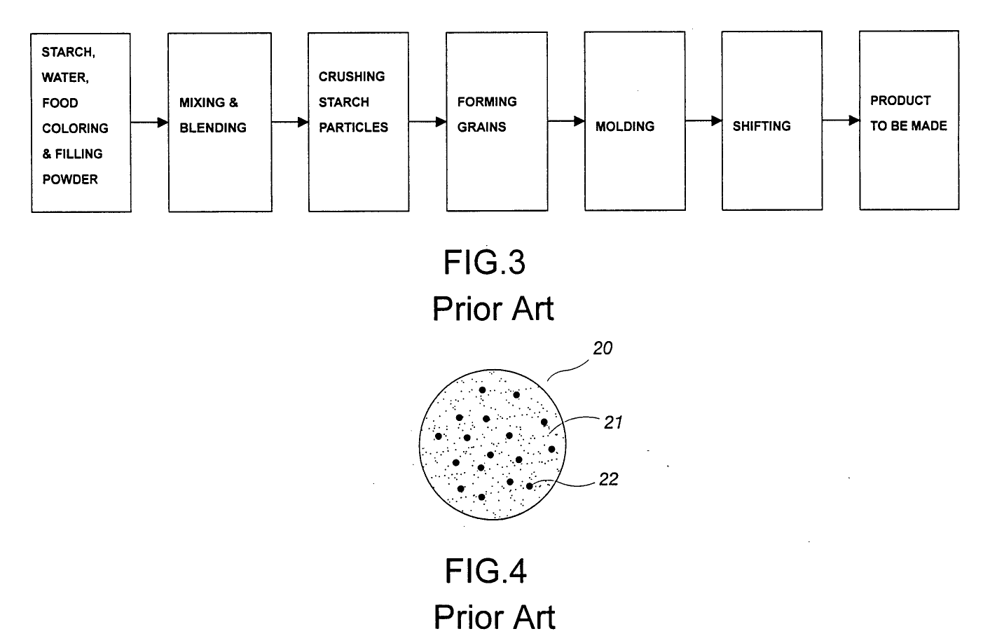

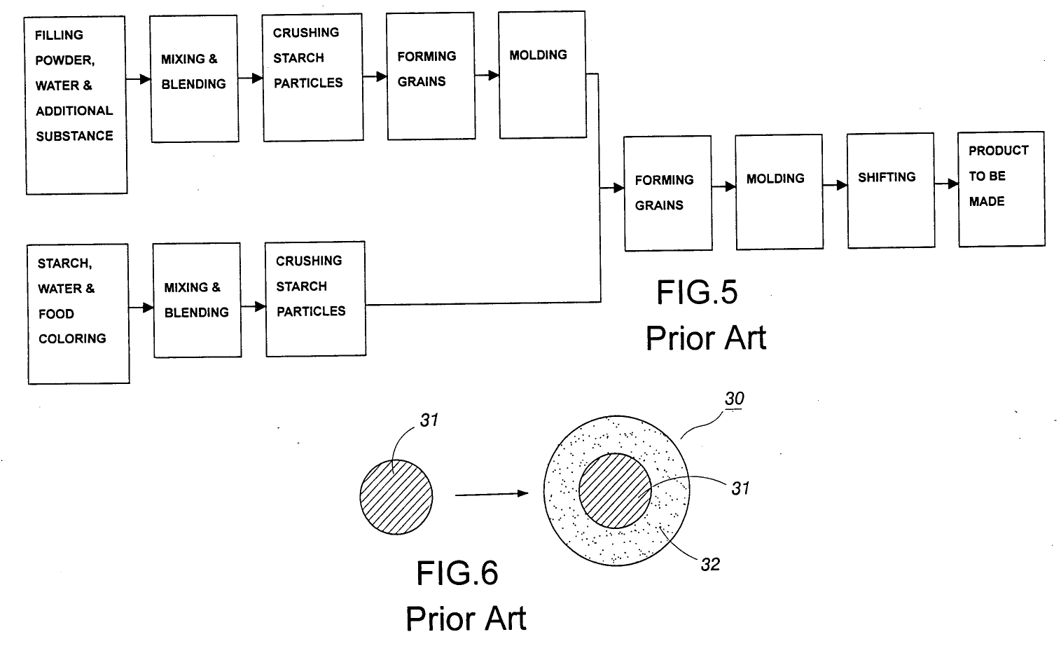

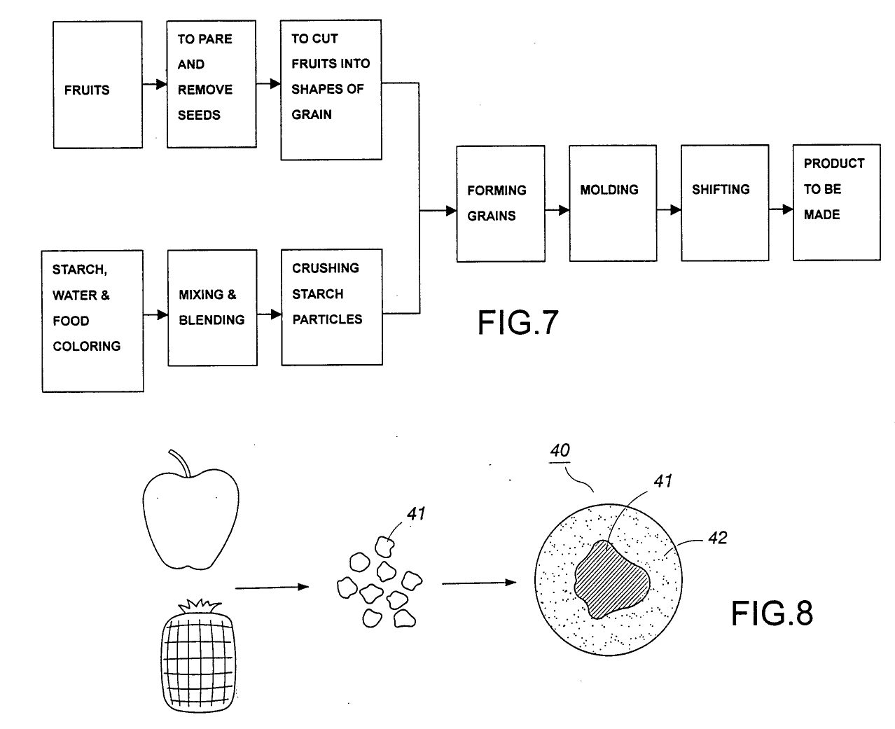

### DETAILED DESCRIPTION OF THE PREFERRED EMBODIMENTS

At the first step, the fruits are pared and cut into grain-shaped filling ingredients in the size of 1-10 mm; at the second step, ten catties of starch, four catties of water and one hundred grams of food coloring are mixed, blended and crushed; finally, the filling ingredients (41) and the starch layer (42) are mixed, through grain forming and molding, the pearl starch ball (40) sized in the range of 5 mm-20 mm are selected by sifting, wherein the best pearl starch balls (40) range from 8 mm to 11 mm; the mentioned filling ball 41 concentrates at the inner center of the pearl starch ball (40) and occupies at least ⅕ to ⅘ of the entire volume; the pearl starch ball (40) are ready to eat after being cooked with water; during chewing, the filling ingredients (41) of the pearl starch ball (40) spreads from the inside to the outside, therefore the luscious flavor of the filling ingredients (41) and the chewy texture of the starch layer (42) can be tasted and thereby satisfy the consumer's palatal desire.

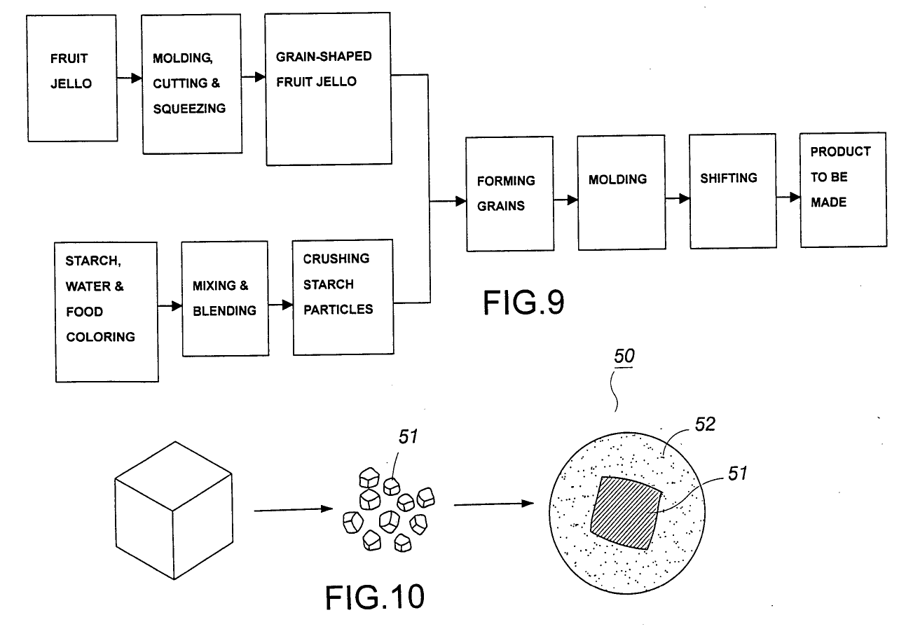

Referring to FIGS. 9 and 10, the manufacturing and the structural drawings of another kind of pearl starch ball of the present invention, as mentioned in the first step, the fruits are in the grain shapes, however, some of the fruits are too soft to be stored in grain shapes, such as the tangerines, the orange, the grapes, etc., therefore, those fruits are squeezed into juice, added with water and gelatin to form fruit jello (51); the said fruit jello is molded, cut or squeezed into grain shapes to replace the natural fruits; finally, the grain-shaped fruit jello (51) and the crushed starch layer (52) from the second step are put into the grain-forming machine to be molded into spherical pearl starch balls (50) through grain forming and molding; the taste resulted from eating the cooked pearl starch ball (50) is not secondary to the grain-shaped natural fruit filling ingredients (41).

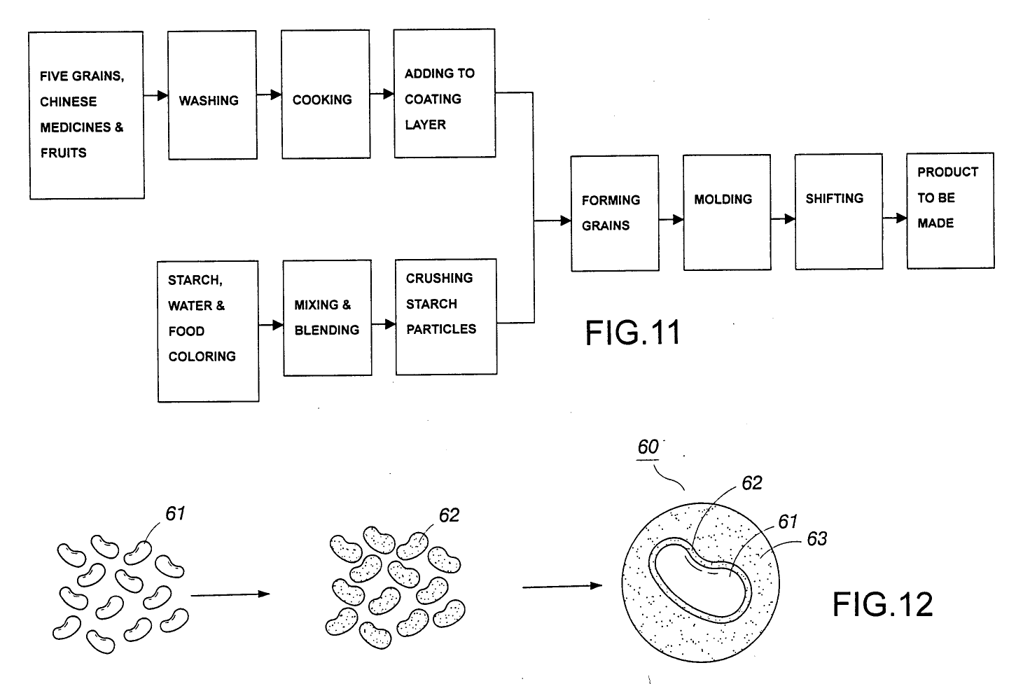

As indicated in FIGS. 11 and 12, the manufacturing and the structural drawings of yet another kind of pearl starch ball of the present invention, the filling ingredients is different from the mentioned and can be further divided into at least more than two ingredient layers, for example, respectively from the inside to the outside, the first layer (61) is of the natural fruits or vegetables, the second layer (62) is the coating layer; the manufacturing method thereof is that an additional coating layer (62) mainly of sugar coating, solidifier and seasonings is added after the grain-shaped natural fruits are molded at the first step; after being molded, the crushed starch layer (63) is added for conducting the grain forming and molding at the third step, finally the pearl starch ball with filling (60) is accomplished.

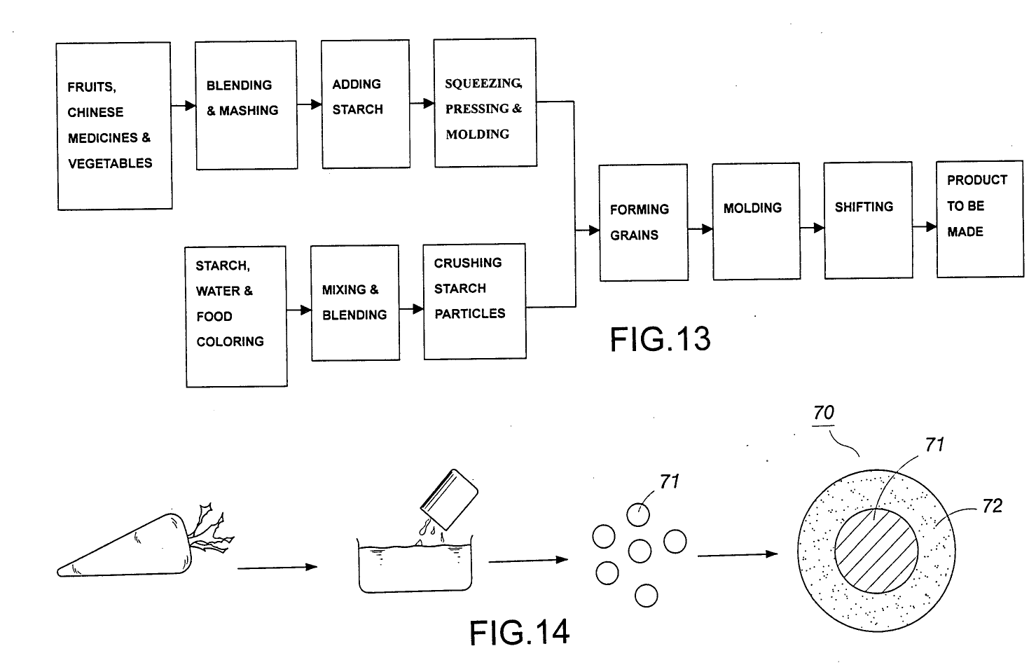

As indicated in FIGS. 13 and 14, the manufacturing and the structural drawings of still another kind of pearl starch ball of the present invention, after blending and mashing the natural fruits, the five grains, the Chinese herb medicines or the vegetables (such as the turnip, the dioscoreae, the spinach, the tomato, the taro, etc.,) starch and the solidifier are added; through squeezing, pressing or molding into grain shapes, the grain-shaped fruits or vegetables (71) and the crushed starch layer (72) are mixed to conduct the grain forming and molding operation at the third step, finally the pearl starch ball with filling (70) is accomplished.

By virtue of the implement of the present invention, the following advantages can be achieved:

1. The filling ingredients inside the pearl starch ball can augment the intensity of the thematic flavor to enable the consumer to taste the flavor of the filling ingredients during chewing and the chewy texture of the original starch layer is reserved.

2. By the same manufacturing method, the number of the layers of the filling ingredients can be two or more than two, the filling ingredients are blended and melted into one unit during chewing to present a pearl starch ball different from the traditional ones.

1. A pearl starch ball product with filling of natural fruits or vegetables comprises of:
a filling ingredient uses the grains of natural fruits as the filling ingredients;
a starch layer is starch covers on the outer layer of the filling ingredient;
a pearl starch ball with filling is composed from the mentioned components; after being cooked, the strong luscious flavor of the filling ingredients and better chewy texture can be tasted during chewing to satisfy the consumer's palatal desire.

2. A pearl starch ball product according to claim 1, wherein the filling ingredients can be grain-shaped and processed five grains.

3. A pearl starch ball product according to claim 1, wherein the filling ingredients can be grain-shaped and processed healthy ingredients from Chinese herb medicines.

4. A pearl starch ball product according to claim 1, wherein the filling ingredients can be grain-shaped fruit jello.

5. A pearl starch ball product according to claim 1, wherein the filling ingredients can be grain-shaped and processed vegetables.

6. Any mentioned pearl starch ball product according to claim 1, wherein the filling ingredients can be divided into at least more than two layers of different ingredient layers, respectively from the inside to the outside, the first layer is a layer of natural fruits or vegetables, the second layer is a coating layer.

7. Any mentioned pearl starch ball product according to claim 1, wherein the volume of the filling ingredients is at least ⅕ or ⅘ of the entire pearl starch ball.
